(19) United States
(12) Patent Application Publication
(10) Pub. No.: US 2007/0002778 A1
(43) Pub. Date: Jan. 4, 2007

(54) Method for query of domain names of telephone numbers

(75) Inventors: Lei Shi, Shenzhen (CN); Yuanwen Wang, Shenzhen (CN); Zhijian Luo, Shenzhen (CN); Sujuan Yang, Shenzhen (CN)

Correspondence Address: Robert Popa, Esq.;c/o LADAS & PARRY, Suite 2100, 5670 Wilshire Boulevard, Los Angeles, CA, 90036-5679, US

(73) Assignee: HUAWEI TECHNOLOGIES CO., LTD.

(21) Appl. No.: 11/450,211

(22) Filed: Jun. 8, 2006

(30) Foreign Application Priority Data
Jun. 8, 2005 (CN) 200510075078.0

(51) Int. Cl. H04L 12/16

(52) U.S. Cl. 370/260

(57) ABSTRACT

The present invention discloses a method for query of domain names of telephone numbers, e.g., E.164 numbers. The method comprises: in ENUM DNS (Electronic numbers to URI Mapping Domain Name System), dividing a domain name of a telephone number into a public domain name part and a digit domain name part; storing sequentially public domain name information separated by spacer(s) in the public domain name part and the data obtained by arranging digits in the digit domain name part in a preset order into nodes of a search tree according to storage rules of the search tree; on receiving a query request, the ENUM DNS obtaining the public domain name information of the domain name and finding the corresponding nodes according to search tree rules; obtaining the digits separated by spacer(s) in the domain name, arranging the digits into data in a prescribed order of the system, and finding the next-level nodes of the search tree. With the method of the present invention the height of the search tree can be effectively reduced, the hash degree of the HASH values generated by the nodes may be improved, and the possibility of conflict may be reduced, thus improving the query efficiency of the system.

### FIELD OF THE INVENTION

The present invention relates to the field of communication and information technology in general. More particularly, the present invention relates to a method for query of corresponding domain names transformed from telephone numbers, e.g., E.164 numbers.

### BACKGROUND OF THE INVENTION

ENUM (Electronic numbers to URI Mapping) is a protocol defined by Electronic number Mapping Workgroup of IETF, i.e., RFC 2916, the title of which is ‘E.164 Number and DNS’. RFC 2916 defines a method of transforming E.164 numbers into domain names and putting these domain names in the database of a DNS server, in which each of the domain name transformed from E.164 numbers corresponds to an URI (Uniform Resource Identifier). In this way, the internationally standardized E.164 numbers become network address resources which may be used in Internet. ENUM DNS(Domain Name System) can make use of a telephone number to search for various information of a registrant such as E-mail addresses, IP telephone numbers, unified messages, IP Faxes, personal homepages and the like. E.164 numbers are important resources used in conventional telecommunication networks, and DNS is the base of Internet, both of which are combined by ENUM, which facilitates the evolvement of conventional telecommunication services towards the direction based on IP packet-switching. Thus, ENUM is of great significance in the integration of the conventional telecommunication networks and Internet.

ENUM defines the following procedure to map telephone numbers to records in DNS:

An E.164 number is composed of several parts as following, in which the different parts can be joined together with ‘-’, ‘.’ or space, etc.:

+Country Number (1-3 digits)-District Number (n digits)-Telephone number (15-n digits). For example, the standard E.164 format of a telephone number in Beijing is: +86-10-62618501.

To find the DNS names for a specific E.164 number, the following procedure is to be followed:

Step 1, see that a telephone number is written in the form of a standard E.164 number, example: +86-10-62618501;

Step 2, remove all non-digit characters with the exception of the leading ‘+’, example: +861062618501;

Step 3, remove ‘+’ and reverse the order of the digits, example: 105816260168;

Step 4, put dots (‘.’) between each digit, example: 1.0.5.8.1.6.2.6.0.1.6.8;

Step 5, append public domain name ‘.e164.tld’ to the end of the above string, example: 1.0.5.8.1.6.2.6.0.1.6.8.e164.tld.

Thus, a telephone number is transformed into a domain name in DNS.

At present, DNS of Internet has realized the transformation of a domain name into an IP address, for example, a domain name ‘www.dongfang.com’ can be transformed into ‘192.172.250.27’. In the prior art, when the information of a domain name is stored by the Domain Name Resolution System, the domain name is separated by spacer(s) ‘.’, split into multiple nodes and stored according to the rules of a search binary tree. For example, the method for storing ‘www.dongfang.com’ and ‘www.163.com’ is shown in FIG. 1. For parallel nodes such as ‘dongfang’ and ‘163’, ‘dongfang’ and ‘163’ are regarded as input character strings to generate HASH values according to the rules set in the system, the position information of the nodes corresponding to the HASH values is stored in a HASH table in the system which is used for query of the nodes corresponding to the domain names.

In the prior art, EUNM DNS system continues to use the same method of query as that of DNS in Internet. For example, for a telephone number 8613512511125, the corresponding domain name is 5.2.1.1.1.5.2.1.5.3.1.6.8.e164.gprs, the storage method of which is shown in FIG. 2, in which it is also separated by spacers “.” and split into multiple nodes to be stored. It can be seen from FIG. 2 that, by adopting this kind of storage method, the search tree will be very tall (each digit of the telephone number corresponds to a parallel node, and the longer the telephone number is, the taller the search tree will be). It takes the system longer time to query the domain name of an E.164 number since it has to query multiple parallel nodes. Furthermore, the length of each node is 1, which means that a node can only be digit 0-9, so only a maximum of 10 HASH values can be generated.

### SUMMARY OF THE INVENTION

An aspect of the present invention provides a method for query of domain names of telephone numbers, e.g., E.164 numbers, wherein the method comprises the steps of:
dividing a domain name of a telephone number into a first part corresponding to the public domain name of the domain name of the telephone number and a second part corresponding to the digital part including a plurality of digits of said domain name;
storing said first part and the second part into the nodes of a search tree according to a predefined rule, wherein said digits are stored in a predefined sequence;
on receiving a query request, querying and obtaining the first part and the second part in the predefined sequence according to the predefined rule.

Preferably, the predefined rule is a storage rule of the search tree.

The method further comprises:

calculating HASH values of the public domain name information of the first part and the data of the second part respectively by using a preset HASH algorithm, and storing the HASH values and the position information of their corresponding nodes;

in the query procedure of the domain name, if failure occurs when searching for the corresponding nodes according to the search rules of the search tree, calculating HASH values of the public domain name information or the data by using the preset HASH algorithm, and determining the corresponding nodes of the search tree according to the calculated HASH values.

Preferably, the HASH values and the position information of their corresponding nodes are stored in a HASH table; the corresponding nodes of the search tree are determined according to the calculated HASH values.

The method further comprises: querying the stored HASH table with the calculated HASH values as indexes to obtain the position information of the corresponding nodes.

Preferably, the public domain name information in the first part is respectively stored in a root node and a next-level sub-node of the search tree in a preset order.

Preferably, the public domain name information in the first part and the data in the second part are stored in a preset order.

The step of arranging the digits in the digit domain name part in the preset order comprises: arranging the digits separated by spacer(s) in the digit domain name part into data in left-to-right or right-to-left order.

The public domain name information in the public domain name part is respectively stored in a root node and a next-level sub-node of the search tree in a preset order.

During the storage procedure of the domain name of the E.164 number, the public domain name information separated by spacer(s) in the public domain name part is combined together in a preset order and stored in the root node of the search tree.

The public domain name information in the public domain name part is combined together in left-to-right or right-to-left order.

Preferably, the search tree is a binary search tree.

Preferably, the public domain name information in the first part is separated by spacer(s).

Preferably, the digits in the second part are separated by spacer(s).

Preferably, the data is obtained by arranging digits in second part.

With the method of the present invention, the number of nodes for the storage of the domain names may be reduced, and the height of the search tree may be lowered.

### BRIEF DESCRIPTION OF THE DRAWINGS

FIG. 1 is a schematic diagram illustrating the nodes of DNS in Internet in which the domain names are stored by using a binary search tree;

FIG. 2 is a schematic diagram illustrating the nodes in which the domain names of E.164 numbers are stored by using a search tree according to the prior art;

FIG. 3 is a schematic diagram illustrating the nodes in which the domain names of E.164 numbers are stored by using a search tree according to an embodiment of the present invention;

FIG. 4 is a schematic diagram illustrating the nodes in which the domain names of E.164 numbers are stored by using a search tree according to an embodiment of the present invention;

FIG. 5 is a schematic diagram illustrating the nodes in which the domain names of E.164 numbers are stored by using a search tree according to an embodiment of the present invention;

FIG. 6 is a schematic diagram illustrating the nodes in which the domain names of E.164 numbers are stored by using a search tree according to an embodiment of the present invention;

FIG. 7 is a schematic diagram illustrating the nodes in which the domain names of E.164 numbers are stored by using a search tree according to an embodiment of the present invention;

FIG. 8 is a schematic diagram illustrating the nodes in which the domain names of E.164 numbers are stored by using a search tree according to an embodiment of the present invention.

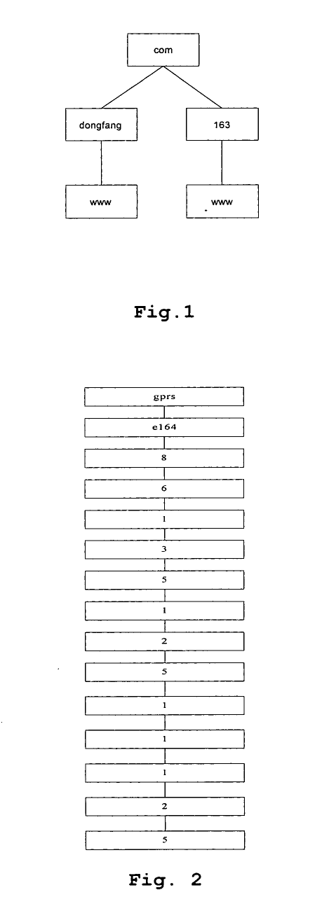

### DETAILED DESCRIPTION OF THE PREFERRED EMBODIMENTS

Hereunder the preferred embodiments of the present invention will be described in detail so as to make the principle, features and advantages of the present invention clearer.

A method for query of the domain names of telephone numbers e.g. E.164 numbers, provided in the embodiment of the present invention, comprising:

in a Domain Name System for Telephone numbers to URI Mapping (ENUM DNS), dividing the domain name of a E.164 number into a public domain name part and a digit domain name part; sequentially storing the public domain name information separated by spacer(s) in the public domain name part and the data obtained by arranging the digits of the digit domain name part in a preset order into the nodes of a search tree according to the storage rules of the search tree;

on receiving a query request for the domain name of the E.164 number, the ENUM DNS obtaining the public domain name information in the domain name and finds the corresponding nodes in the search tree according to the search rules of the search tree; and obtaining the digits separated by spacer(s) in the domain name, arranging them to data in order set in the system, and finding the next-level nodes of the search tree.

To improve the query efficiency of the system, the method of the embodiment of the present invention further comprises the steps of calculating HASH values of the public domain name information and the data respectively by utilizing specified HASH algorithm, and then storing the position information of the nodes to which the HASH values correspond.

During the procedure for the query of domain names, if the searching of the corresponding nodes according to the search rules of the search tree is unsuccessful, HASH values of the public domain name information or the data being queried will be calculated using the HASH algorithm set in the system, and the corresponding nodes of the search tree are determined according to the calculated HASH values.

The position information of the nodes to which the HASH values correspond is stored in a HASH table. Particularly, the method of determining the corresponding nodes of the search tree according to the calculated HASH values is: searching in the stored HASH table with the calculated values as indexes and obtaining the position information of the corresponding nodes.

Hereunder the method of the present invention will be described in detail by using two embodiments as the examples respectively.

### Embodiment 1

The public domain names separated by spacer(s) in the public domain name part are respectively stored in right-to-left order in the root node and the next-level sub-node in the search tree.

Take the telephone number ‘8613512511125’ for an example, according to the transformation rules of E.164 numbers to domain names, the domain name format of the number is ‘5.2.1.1.1.5.2.1.5.3.1.6.8.e164.gprs’, in which ‘e164.gprs’ is the public domain name appended by the system (the public domain name can be set in the system by users, and the system will append the public domain name part into the domain name transformed from the telephone number according to the preset domain name). In ENUM DNS, the domain name transformed from the E.164 number is stored according to the storage rules of the search tree, compared with the prior art in which “.” is used as spacer in the information to which the nodes correspond in order to store each digit in one node, the transformed domain name is divided into a public domain name part and a digit domain name part to be stored respectively. Particularly, the method is as the following:

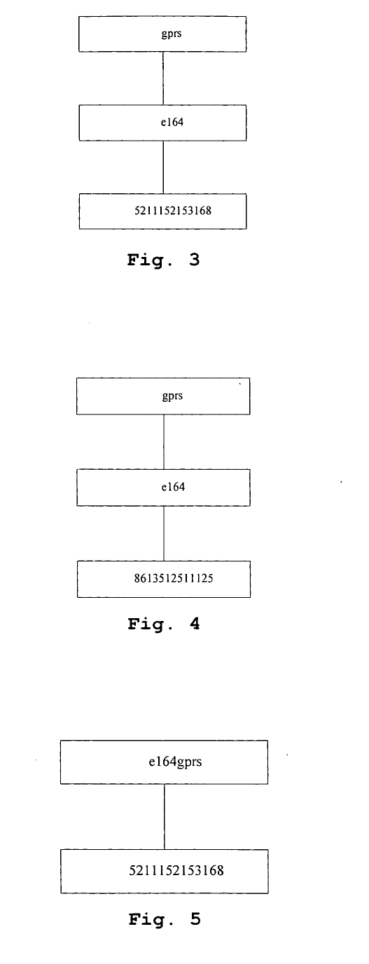

The public domain name information separated by spacer(s) ‘.’ is stored in the root node and a sub-node in a search tree according to the storage rules of the search tree, as shown in FIG. 3 and FIG. 4. Here the search tree can be a binary search tree or other types of search trees;

The system calculates HASH values corresponding to individual domain name information(‘e164’ and ‘gprs’) separated by spacer(s) ‘.’ in the public domain name part according to the preset HASH algorithm, and stores the position information of the corresponding nodes in a HASH table.

The system arranges the rest of the digits separated by spacer(s) ‘.’ into data in a preset order, and stores the data in a corresponding sub-node according to the storage rules of the search tree, as shown in FIG. 3 and FIG. 4. The arrangement of the digits can be set by the system, and for simplicity and convenience, the digits can be arranged in the left-to-right order or in the right-to-left order. Referring to the above examples, the data arranged in the left-to-right order is 5211152153168 (see FIG. 3); the data arranged in the right-to-left order is 8613512511125 (see FIG. 4).

After the data is arranged, the system calculates HASH values of the data according to the preset HASH algorithm, and stores the position information of the corresponding nodes in the HASH table as mentioned above.

When a query request for the domain names of a E.164 number is received, for example, when an user inputs a domain name of ‘5.2.1.1.1.5.2.1.5.3.1.6.8.e164.gprs’, the ENUM DNS obtains the public domain name information ‘e164.gprs’ of the public domain name part, and finds the root node ‘gprs’ and the sub-node ‘e164’ corresponding respectively to the domain names separated by spacer(s) in the public name information (e164 and gprs) according to the search rules of the search tree; then obtains the rest of digits separated by spacers in the domain name, arranges them into data ‘5211152153168’ or ‘8613512511125’ in the preset orders in the system, and finds the next-level node of the search tree. If the corresponding node is not found successfully according to the search rules of the search tree, for example, if the corresponding node of data ‘5211152153168’ is found unsuccessfully, the system calculates HASH values of data ‘5211152153168’ according to the preset HASH algorithm and queries the stored HASH table with the calculated HASH value as index to obtain the position information of the corresponding nodes.

### Embodiment 2

The public domain names separated by spacer(s) in the public domain name part are combined together in a set order, and stored in the root node of a search tree.

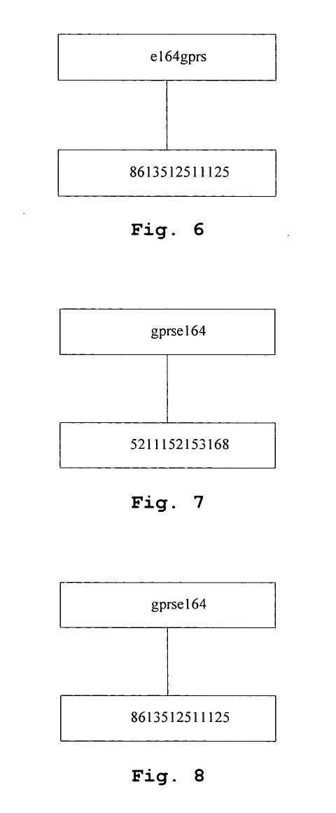

Take the domain name ‘5.2.1.1.1.5.2.1.5.3.1.6.8.e164.gprs’ for an example, when it is stored in the search tree, public name ‘e164.gprs’ will be combined together and stored in the root node of the search tree. The public name can be combined into ‘e164gprs’ in a left-to-right order(see FIG. 5 and FIG. 6) or combined into ‘gprse164’ in a right-to-left order (see FIG. 7 and FIG. 8) to be stored. The storage method of the data part is as same as the method mentioned above, that is, the digits can be arranged in the left-to-right order as ‘5211152153168’ or arranged in the right-to-left order as ‘8613512511125’. In this way, according to the order of the combination of the public domain names and arrangement of the digits, there are four combination and storage modes:

combination and storage mode 1: the public domain names are combined in left-to-right order and the digits are arranged in left-to-right order, as shown in FIG. 5;

combination and storage mode 2: the public domain names are combined in left-to-right order and the digits are arranged in right-to-left order, as shown in FIG. 6;

combination and storage mode 3: the public domain names are combined in right-to-left order and the digits are arranged in left-to-right order, as shown in FIG. 7;

combination and storage mode 4: the public domain names are combined in right-to-left order and the digits are arranged in right-to-left order, as shown in FIG. 8.

On receiving a query request for the domain name of an E.164 number, for example, when an user inputs a domain name of ‘5.2.1.1.1.5.2.1.5.3.1.6.8.e164.gprs’, the ENUM DNS obtains the public domain name information ‘e164.gprs’ of the public domain name part, and combines the individual domain names (e164 and gprs) separated by spacer according to the preset combination mode of the system. For example, the public domain names may be combined into ‘e164gprs’ in the left-to-right order or into ‘gprse164’ in the right-to-left order, and the root node may be found according to the search rules of the search tree; then the digits separated by spacers may be obtained and arranged into data ‘5211152153168’ or ‘8613512511125’ in the preset order of the system, and the next-level node of the search tree is found. If the corresponding node is not found successfully according to the search rules of the search tree, for example, if the node to which data ‘5211152153168’ corresponds is not found successfully, the system calculates HASH values of data ‘5211152153168’ according to the preset HASH algorithm and queries the stored HASH table with the calculated HASH values as indexes, thereby the position information of the corresponding nodes will be obtained.

It is appreciated for the skilled in the art that the telephone numbers may be not limited to E.164 numbers, various variations and modifications may be made to the present invention within the spirit and scope of the present invention, and it is intended that the present invention covers theses variations and modifications provided that they fall within the scope of the present invention as defined by the appended claims and their equivalents.

1. A method for query of domain names of telephone numbers, wherein the method comprises the steps of
dividing a domain name of an telephone number into a first part corresponding to the public domain name of the domain name of the telephone number and a second part corresponding to the digital part including a plurality of digits of the domain name;
storing said first part and the second part into the nodes of a search tree according to a predefined rule, wherein the digits are stored in a predefined sequence;
on receiving a query request, querying and obtaining the first part and the second part in the predefined sequence according to the predefined rule.

2. The method according to claim 1, wherein the predefined rule is a storage rule of the search tree.

3. The method according to claim 1, wherein the storing step comprises: calculating HASH values of the public domain name information of the first part and the data in the second part respectively by using a preset HASH algorithm, and storing the HASH values and the position information of their corresponding nodes.

4. The method according to claim 3, wherein the querying comprises: if failure occurs when searching for the corresponding nodes according to the search rules of the search tree, calculating HASH values of the public domain name information or the data by using the preset HASH algorithm, and determining the corresponding nodes of the search tree according to the calculated HASH values.

5. The method according to claim 4, wherein the HASH values and the position information of their corresponding nodes are stored in a HASH table; the corresponding nodes of the search tree are determined according to the calculated HASH values.

6. The method according to claim 5, wherein the method comprises: querying the stored HASH table with the calculated HASH values as indexes to obtain the position information of the corresponding nodes.

7. The method according to claim 6, wherein the search tree is a binary search tree.

8. The method according to claim 1, wherein the public domain name information in the first part is respectively stored in a root node and a next-level sub-node of the search tree in a preset order.

9. The method according to claim 8, wherein the search tree is a binary search tree.

10. The method according to claim 1, wherein the step of arranging the digits in the digit domain name part in the preset order comprises: arranging the digits separated by spacer(s) in the digit domain name part into data in left-to-right or right-to-left order.

11. The method according to claim 1, wherein during the storage procedure of the domain name of the telephone number, the public domain name information in the first part is combined together in a preset order and stored in the root node of the search tree.

12. The method according to claim 11, wherein the public domain name information in the first part is combined together in left-to-right or right-to-left order.

13. The method according to claim 12, wherein the search tree is a binary search tree.

14. The method according to claim 1, wherein the search tree is a binary search tree

15. The method according to claim 1, wherein the public domain name information in the first part is separated by spacer(s).

16. The method according to claim 1, wherein the digits in the domain name are separated by spacer(s).

17. The method according to claim 3, wherein the data is obtained by arranging the digits in the second part.

18. The method according to claim 1, wherein the public domain name information in the first part and the data in the second part are stored in a preset order.

19. The method according to one of claim 1, wherein said telephone number is an E.164 number.
